(19) United States
(12) Patent Application Publication
(10) Pub. No.: US 2013/0346591 A1
(43) Pub. Date: Dec. 26, 2013

(54) Clientless Cloud Computing

(71) Applicants: Martin D. Carroll, Watchung, NJ (US); Larry D. Liu, Whitehouse Station, NJ (US)

(72) Inventors: Martin D. Carroll, Watchung, NJ (US); Larry D. Liu, Whitehouse Station, NJ (US)

(73) Assignee: ALCATEL-LUCENT USA INC., Murray Hill, NJ (US)

(21) Appl. No.: 13/529,533

(22) Filed: Jun. 21, 2012

(51) Int. Cl. G06F 15/173

(52) U.S. Cl. 709/224

(57) ABSTRACT

Methods, apparatuses and articles of manufacture for clientless cloud-computing are provided. Clientless cloud-computing may be implemented by detecting a plurality of input/output devices, at least a portion of the plurality of input/output devices associated with a unique identifier and available to be communicatively bound to a cloud-resident computer. A binding preference, including a selection of an input/output device, is received. The selection includes the unique identifier associated with the selected input/output device. A binding request to the selected input/output device is transmitted, and the selected input/output device is communicatively bound with the cloud-resident computer.

### TECHNICAL FIELD

The present disclosure is generally directed to computer input/output devices, and more specifically to network-attached input/output devices configured for cloud-computing applications.

### BACKGROUND

Initially, computer input/output (I/O) devices were an integral part of the computer itself. Some I/O devices such as telephone-switchboard plugs were part of the physical construction of the machines while others such as operator consoles and printers were connected by cable to the main body of the computer. However, these devices were integral parts of the computing system, and users were not expected to unplug them, replace them, or move them around.

With the introduction of time sharing, enabling multiple simultaneous users to access the same computer, typically from remote terminals, became necessary. These remote terminals often had integrated I/O devices (typically a keyboard and printer) and were connected via a network (which was often the telephone network) or a simple collection of wires, to the computer itself.

When personal computers (PCs) were introduced, they often included integrated I/O devices. For example, a PC often included an integrated monitor, a keyboard and one or more integrated floppy disk drives. PCs also provided nonintegrated I/O devices, such as printers and mouse pointers, that users were free to unplug, to move around, and to replace.

For cloud computing, the computer has moved away from the user into the networked cloud environment. The computer also is no longer restricted to being a physical computer: cloud-resident computers can be physical or virtual. In cloud-computing systems, users typically access the cloud-based computers via remote terminals, which are often thin clients that may support both integrated and user attached I/O devices.

However, in these I/O device/computer configurations, attaching a desired set of I/O devices to a given (local or remote, physical or virtual) computer may be difficult. For example, a user who wishes to use a specific monitor, keyboard, or joystick (e.g., to play a game that is running on a cloud-resident computer) must first physically attach these I/O devices to a specific remote terminal (or find a remote terminal that provides integrated versions of some or all of those devices). However, users often do not know how to attach I/O devices to remote terminals. Even for knowledgeable users, the need to physically move I/O devices to be closer to a remote terminal can be an annoyance. Moreover, if a remote terminal runs out of free I/O connecting ports, more ports must be added or an attached I/O device must be disconnected to add a new I/O device.

### SUMMARY

To eliminate physically moving and plugging-in I/O devices to client devices, and to enable various cloud-based applications, methods, systems and articles of manufacture for dynamically associating a desired set of I/O devices with a specified cloud-resident computer are provided.

In accordance with an embodiment, a plurality of input/output devices are detected. At least a portion of the plurality of input/output devices are associated with a unique identifier and available to be communicatively bound to a cloud-resident computer. A binding preference including a selection of an input/output device specified by a user is received, the selection including the unique identifier associated with the selected input/output device. A binding request is transmitted to the selected input/output device, and the selected input/output device is communicatively bound with the cloud-resident computer. A listing of the portion of the plurality of input/output devices may be presented to a user and a binding acceptance may be received from the selected input/output device.

In accordance with an embodiment, another input/output device is automatically selected for binding with the cloud-resident computer based on the received binding preference.

In accordance with an embodiment, a TCP address for the cloud-resident computer is determined, and the TCP address is transmitted to the selected input/output device.

In accordance with an embodiment, input/output communications are routed between the selected input/output device and the cloud-resident computer. TCP-based or UDP-based communications may be established between the selected input/output device and the cloud-resident computer.

In accordance with an embodiment, input/output communications received from the selected input/output device or the cloud-resident computer are converted from a first format to a second format, wherein the second format is based on a protocol that is understood by a recipient of the input/output communications.

In accordance with an embodiment, a binding preference including a selection of a cloud-resident computer is received, and a binding request to the selected cloud-resident computer is transmitted.

These and other advantages of the invention will be apparent to those of ordinary skill in the art by reference to the following detailed description and the accompanying drawings.

### BRIEF DESCRIPTION OF THE DRAWINGS

FIG. 1 is a diagram showing a cloud-computing environment that may be used for implementing clientless cloud-computing in accordance with an embodiment;

FIG. 2 is a diagram showing a clientless input/output device configuration for implementing clientless cloud-computing in accordance with an embodiment;

FIG. 3 is a diagram showing another view of a cloud-computing environment that may be used for implementing clientless cloud-computing in accordance with an embodiment;

FIG. 4 is a flowchart of a process for implementing clientless cloud-computing in accordance with an embodiment; and

FIG. 5 is a high-level block diagram of an exemplary computer that may be used for implementing clientless cloud computing.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

In accordance with the various embodiments, clientless input/output devices (also referred to herein as clientless I/O devices, I/O devices or devices) are communicatively bound to a cloud-resident computer via a cloud-computing network. Clientless I/O devices that are communicatively bound to a cloud-resident computer can reside at geographically remote locations with respect to the cloud-resident computer or with respect to each other, including any location having network connectivity. A clientless I/O device that is communicatively bound to a cloud-resident computer can be attached to a different network from the cloud-resident computer, and may maintain connectivity with the cloud-resident computer through one or more intervening networks. An interface between a clientless I/O device and a cloud-computing network can be physical (i.e., wired), wireless or any combination thereof.

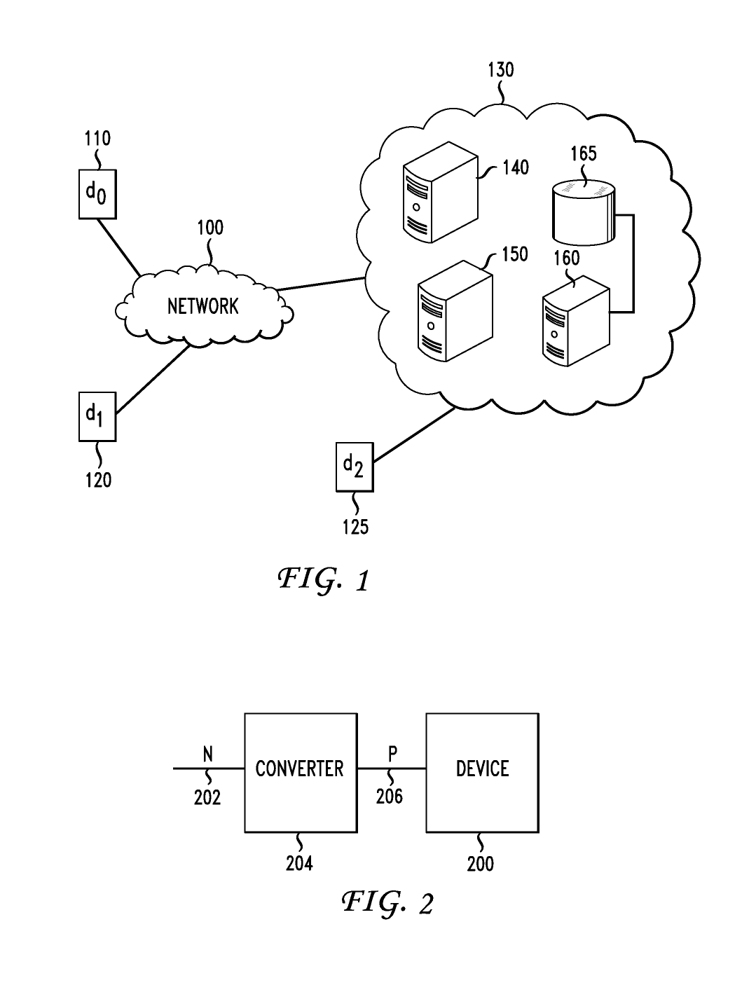

FIG. 1 is a diagram showing a cloud-computing environment that may be utilized for implementing clientless cloud-computing in accordance with an embodiment. Clientless cloud-computing can be provided through cloud-computing environment 130. Clientless I/O devices, such as I/O device d₀ 110 and I/O device d₁ 120, can communicate with cloud-computing environment 130 via one or more intervening networks, such as via network 100. Alternatively, an I/O device, such as I/O device d₂ 125, can communicate directly with cloud-computing environment 130 without an intervening network. I/O devices d₀ 110, d₁ 120 and d₂ 125 can be dynamically bound to one or more of cloud-resident computers 140, 150, and 160 (also referred to herein as computers) within cloud 130. For example, I/O devices d₀ 110, d₁ 120 and d₂ 125 may transmit inputs to, and receive outputs from, one or more cloud-based applications executing on one or more of cloud-resident computers 140, 150, and 160. An I/O device may be bound to a particular computer executing an application, or an I/O device may be concurrently or dynamically bound to multiple computers, each of which may be executing a portion or all of an application at any given time. For example, computer 140 may provide a cloud-based application, such as a spreadsheet, photo album, word processor, map or video recording application. The cloud-based application may access a document stored in database 165, via computer 160 (i.e., a database server), and access to the document can be provided via a web-page at computer 150. At any given time during the execution of such an application, I/O devices 110, 120 and 125 may be dynamically bound (or unbound) to cloud-resident computers 140, 150, and 160 as necessary.

FIG. 2 is a diagram showing a clientless input/output device configuration for implementing clientless cloud-computing in accordance with an embodiment. Clientless I/O device 200 may access network 100 (or directly access cloud 130), via interface N 202. While interface N 202 may be any I/O-connector type (e.g., USB, SATA, VGA, DVI, HDMI, TRS, PS2, FireWire, etc.), in one exemplary embodiment, interface N 202 is compatible with a single, standardized format for network connectivity. For example, interface N 202 may be an Ethernet connector. As such, device 200 may be a networked mouse employing an Ethernet interface instead of a standard PS2 or USB interface, or a networked monitor employing an Ethernet interface instead of a standard VGA or DVI interface.

Those skilled in the art will note that for devices that are compatible with networked (e.g., Ethernet) device protocols (i.e., native networked devices), a converter for converting non-networked I/O device protocols into networked (e.g., Ethernet) device protocols will not be necessary. However, for the instances where device 200 is a conventional (non-networked) device, device 200 may communicate with converter 204 for converting non-networked I/O device protocols into networked (e.g., Ethernet) device protocols. Converter 204 may be physically implemented by an FPGA-based board, an ASIC or by a combination of hardware and software subject to desired size, cost, power and performance requirements. In one embodiment, converter 204 is in communication with interface N 202 (a first network-facing interface) and a second device-facing interface P 206. For example, device-facing interface P 206 may be compatible with any pre-existing native device protocol. For any input or output communication to or from device 200, converter 204 may convert the native protocol of device 200 into an application-layer protocol that is recognized by a network or vice versa. For example, converter 204 may convert output communications received from device 200 from a first format to a second format, wherein the second format is based on a protocol that is understood by a cloud-resident computer. Likewise, converter 204 may convert input communications received from a cloud-resident computer from a first format to a second format, wherein the second format is based on a protocol that is understood by device 200.

In another embodiment, converter 204 may tunnel the existing native protocol of device 200 over Internet protocol (e.g., USB over IP) subject to quality of service (QoS) requirements. As such, device 200 may be bound to a cloud-resident computer without being configured for a network-compatible protocol. For example, cloud-resident computers may run an operating system (OS) such as Windows® or Linux® that is compatible with typical I/O protocols (such as DVI and USB), rather than a non-typical I/O or custom protocol. In such case, converter 204 may tunnel a native protocol of a (non-Ethernet) device 200 by receiving native control and data packets transmitted from device 200 and then converting the control and data packets for retransmission within network protocol packets. A cloud-resident computer may then remove the tunneled control and data packets from the network-protocol packets and present the data packets to the computer OS as if they had come from a locally attached I/O device. The procedure is reversed in the downstream direction (i.e., from the cloud-resident computer to the I/O device).

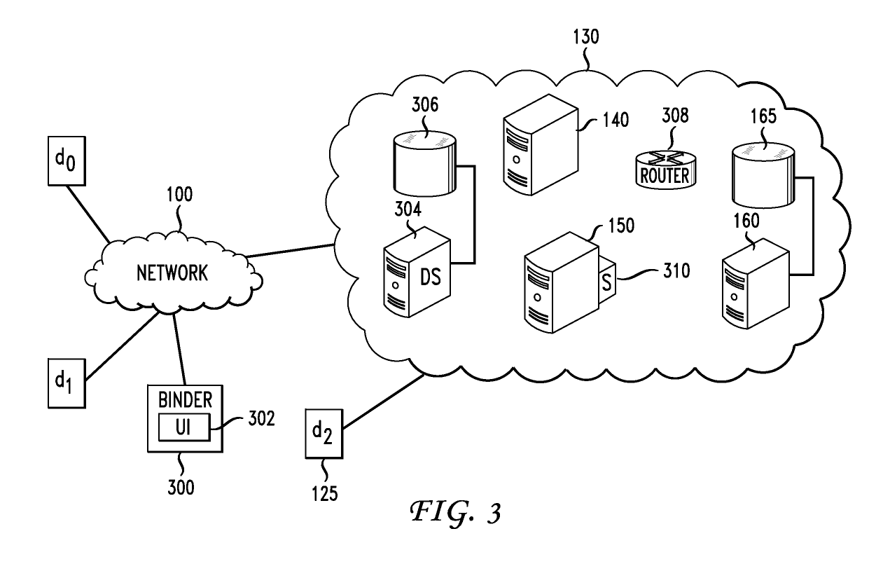

FIG. 3 is a diagram showing another view of a cloud-computing environment that may be used for implementing clientless cloud-computing in accordance with an embodiment. In the clientless cloud-computing network of FIG. 3, binder 300 communicates binding requests to I/O devices d₀ 110, d₁ 120 and d₂ 125, such as via network 100. For example, binder 300 can be implemented via a mobile (e.g., handheld) device including an integrated user interface 302. Alternatively, binder 300 may be a fixed computer terminal that is accessible via other devices (e.g., via an external device user interface that is in communication with binder 300). In addition, while binder 300 is described herein as a discrete element, one skilled in the art will note that the functions of binder 300 (and the binding requests sent to binder 300), may be performed by (and sent to) other elements in the clientless cloud-computing network of FIG. 3, including one or more elements (e.g., cloud-resident computers 140, 150, and 160) that may incorporate functions for managing bindings.

User interface 302 presents a dynamic or periodically updated listing of available I/O devices, cloud-resident computers or both available I/O devices and cloud-resident computers to a user. For example, in operation binder 300 may allow a user to initiate a binding between a selected I/O device and a cloud-resident computer based on a listing presented at user interface 302. In one embodiment, a user may initiate a binding from a near location with respect to the location of a selected I/O device (e.g., a location adjacent to the selected I/O device) or from a remote location with respect to the location of a selected I/O device. As such, one or more functions of binder 300 may be implemented on a mobile handheld device (e.g., by a software application configured to run on a smart-phone) that may be unique to a particular user.

A binding process may be initiated when a user selects a device or cloud-resident computer from a listing presented at user interface 302, such as by selecting a BIND initiator. Alternatively, a user may select a cloud-resident application (in lieu of a cloud-resident computer) from the listing presented at user interface 302. In another alternative embodiment, the binding process may be initiated by a cloud-resident computer. When a binding process is initiated, binder 300 may access a look-up table of one or more IP address entries matching each cloud-resident computer that is available to be bound. Binder 300 may be pre-configured with IP addresses of available computers or, alternatively, binder 300 may discover available cloud-resident computers, such as by a personal identifier assigned to user. For example, whenever a user wishes to update a listing of available cloud-resident computers, binder 300 may transmit an enumeration request containing the user's personal identifier to discovery server 304 (e.g., within the cloud), which maintains database 306 that contains a listing of cloud-resident computers that are currently available to each user/subscriber. In one embodiment, discovery server 304 may be maintained by a service provider for cloud environment 130. When discovery server 304 receives the enumeration request, discovery server 304 may consult a database to return a user listing to binder 300 (e.g., in the form of qualified domain names). Alternatively, if a user is subscribed to more than one cloud provider, binder 300 may be configured to interrogate multiple discovery servers for available cloud-resident computers. Binder 300 may also provide an UNBIND initiator, which when selected by a user causes a selected I/O device to be unbound from a cloud-resident computer.

To discover available I/O devices, binder 300 may receive periodic announcements (e.g., beacon signals) from I/O devices announcing their presence. Alternatively, binder 300 may monitor a network for messages that are indicative of I/O devices or actively scan a network (e.g., based on geography or user proximity) for I/O devices. In one embodiment, binder 300 may read or ascertain an IP address for an I/O device, such as by scanning a device display (e.g., an LCD display or bar code) indicating a current IP address associated with a selected I/O device. Alternatively, a device may include a globally unique, fixed identifier such as a MAC address or a human-readable character string that is detectable by binder 300. Further, an I/O device may be self-identifying. In various embodiments, an I/O device such as a network-attached monitor may flash its screen upon receiving a signal from binder 300, while network-attached speakers may be programmed for a distinctive sound response, or a network-attached joystick may be made to rumble, and so forth. For example, user interface 302 may present a FLASH initiator that, when selected by a user, causes a selected I/O device currently on the listing of available I/O devices to identify itself (e.g., by flashing, beeping, rumbling, etc.).

After a binding, traffic router 308 within cloud 130 may arrange for the I/O traffic from the selected I/O device (e.g., device 110, 120 or 125) to be routed to the cloud-resident computer (e.g., computer 140, 150 or 160). Various mechanisms can be implemented within the cloud to route I/O traffic from a selected I/O device to a cloud-resident computer. For example, a physically manifested cloud-resident computer, such as computer 150, may include streamer 310 for managing and terminating I/O traffic routed to an attached computer. Streamer 310 may be implemented, for example, by a custom PCI Express card with an external network interface.

In one embodiment, binder 300 can inform a selected I/O device of a binding request by providing a TCP address associated with a streamer 310. The selected I/O device then may initiate a TCP control connection to streamer 310 and establish TCP or UDP communication for I/O traffic. Unbinding can be implemented by terminating the TCP and UDP communications. Alternatively, binder 300 may communicate with traffic router 308 to redirect device traffic between bound computers and I/O devices.

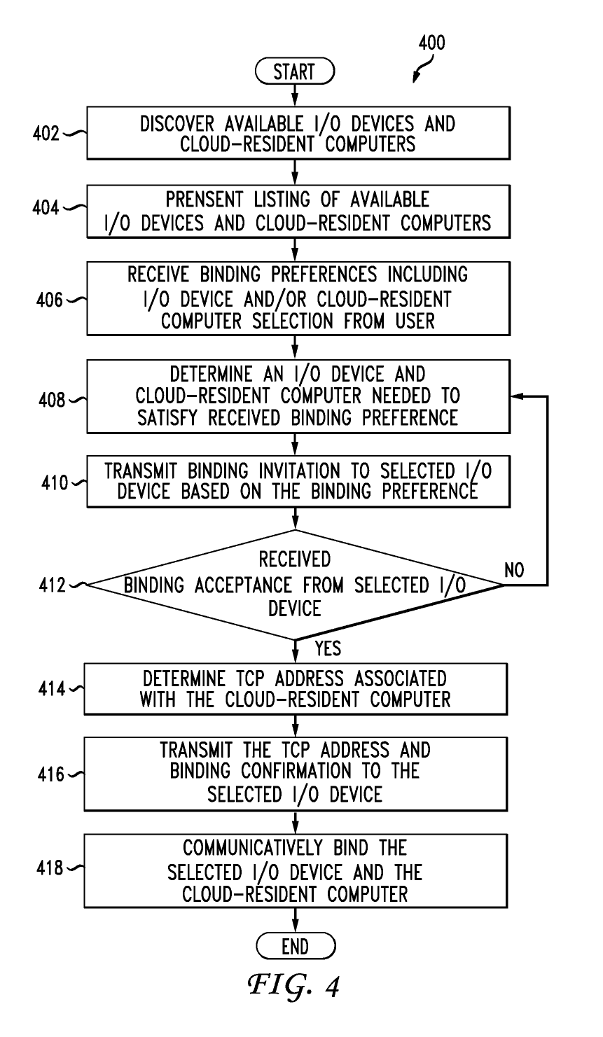

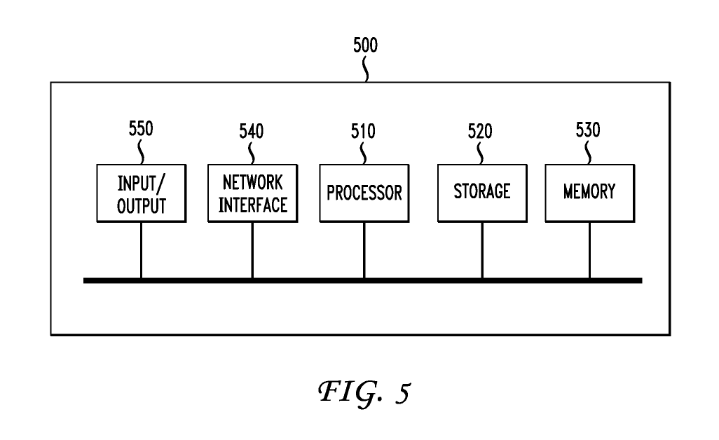

FIG. 4 is a flowchart of a process for implementing clientless cloud-computing in accordance with an embodiment. In process 400, a plurality of input/output devices are detected, wherein the plurality of input/output devices each include a unique identifier and are available to be communicatively bound to a cloud-resident computer at 402. For example, available I/O devices may be discovered by binder 300, or a user may specify a device for binding, such an adjacent public monitor, keyboard or the like.

At 404, a listing of available I/O devices is presented to a user, such as via user interface 302 of binder 300. At 406, a binding preference including a selection of a an input/output device or a cloud-resident computer specified by the user is received, the selection including the unique identifier for the selected input/output device. For example, a binding preference may also include a selection for an I/O device, a cloud-resident computer or both. At 408, the selected I/O device and the cloud-resident computer needed to satisfy the received binding preference are determined and a binding request, including a determined TCP address associated with the cloud-resident computer, is transmitted to the selected I/O device based on the binding preference at 410.

At 412, a success/fail message is received from the selected I/O device indicating whether or not the binding is successful. If successful, the selected input/output device is communicatively bound with the cloud-resident computer, and I/O traffic may be routed between the selected I/O device and the cloud-resident computer at 414.

If the binding fails, an alternative binding may be selected, either by a user (e.g., via binder 300) or automatically (e.g., based on a user's previous binding preference) at 408.

As such, a model for discovering, binding, and controlling I/O devices is disclosed where I/O devices are attached directly to a cloud-based network, and may be dynamically bound to cloud-resident computers. Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud-computing system. In such a network-based cloud-computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 4. Certain steps of the methods described herein, including one or more of the steps of FIG. 4, may be performed by a server or by another processor in a network-based cloud-computing system. Certain steps of the methods described herein, including one or more of the steps of FIG. 4, may be performed by a client computer in a network-based cloud-computing system. The steps of the methods described herein, including one or more of the steps of FIG. 4, may be performed, in part or in full, by a server or by a client computer in a network-based cloud-computing system, or by a combination of a server and a client computer.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 4, may be implemented using one or more computer programs that are understood by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 5. Computer 500 comprises a processor 510 operatively coupled to a data storage device 520 and a memory 530. Processor 510 controls the overall operation of computer 500 by executing computer program instructions that define such operations. The computer program instructions may be stored in data storage device 520, or other computer readable medium, and loaded into memory 530 when execution of the computer program instructions is desired. Thus, the method steps of FIG. 4 can be defined by the computer program instructions stored in memory 530 or data storage device 520 and controlled by processor 510 executing the computer program instructions. For example, the computer program instructions can be implemented as computer understood code programmed by one skilled in the art to perform an algorithm defined by the method steps of FIG. 4. Accordingly, by executing the computer program instructions, the processor 510 executes an algorithm defined by the method steps of FIG. 4. Computer 500 also includes one or more network interfaces 540 for communicating with other devices via a network. Computer 500 also includes one or more input/output devices 550 that enable user interaction with computer 500 (e.g., display, keyboard, mouse, speakers, buttons, etc.).

Processor 510 may include both general and special purpose microprocessors, and may be the sole processor or one of multiple processors of computer 500. Processor 510 may comprise one or more central processing units (CPUs), for example. Processor 510, data storage device 520, and memory 530 may include, be supplemented by, or be incorporated in, one or more application-specific integrated circuits (ASICs) or one or more field programmable gate arrays (FPGAs).

Data storage device 520 and memory 530 each comprise a tangible non-transitory computer readable storage medium. Data storage device 520, and memory 530, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 550 may include peripherals, such as a printer, scanner, display screen, etc. For example, input/output devices 550 may include a display device such as a cathode ray tube (CRT), plasma or liquid crystal display (LCD) monitor for displaying information to the user, a keyboard, and a pointing device such as a mouse or a trackball by which the user can provide input to computer 500.

Any or all of the systems and apparatus discussed herein, including I/O devices 110, 120, 120 and 200, converter 204, interfaces 202 and 206, computers 140, 150 and 160, discovery server 304, databases 165 and 306, streamer 310 and traffic router 308 may be implemented using a computer such as computer 500.

One skilled in the art will recognize that an implementation of an actual computer or computer system may have other structures and may contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

We claim:

1. An apparatus comprising:
a data storage device; and
a processor communicatively coupled to the data storage device, the processor in cooperation with the data storage device configured to:
detect a plurality of input/output devices, at least a portion of the plurality of input/output devices associated with a unique identifier and available to be communicatively bound to a cloud-resident computer;
receive a binding preference including a selection of an input/output device and a cloud-resident computer to which the selected input/output device should be communicatively bound, the selection including the unique identifier associated with the selected input/output device;
transmit a binding request to the selected input/output device; and
communicatively bind the selected input/output device with the cloud-resident computer.

2. The apparatus of claim 1, wherein the processor is further configured to present a listing of the portion of the plurality of input/output devices to a user.

3. The apparatus of claim 1, wherein the processor is further configured to automatically select another input/output device for binding with the cloud-resident computer based on the received binding preference.

4. The apparatus of claim 1, wherein the processor is further configured to present a listing of cloud-resident computers to a user.

5. The apparatus of claim 1, wherein the processor is further configured to:
determine a TCP address for the cloud-resident computer; and
transmit the TCP address to the selected input/output device.

6. The apparatus of claim 1, wherein communicatively binding comprises routing input/output communications between the selected input/output device and the cloud-resident computer.

7. The apparatus of claim 6, wherein routing input/output communications between the selected input/output device and the cloud-resident computer includes establishing TCP-based communications between the selected input/output device and the cloud-resident computer.

8. The apparatus of claim 6, wherein routing input/output communications between the selected input/output device and the cloud-resident computer includes establishing UDP-based communications between the selected input/output device and the cloud-resident computer.

9. The apparatus of claim 6, wherein the processor is further configured to convert input/output communications received from the selected input/output device or the cloud-resident computer from a first format to a second format, wherein the second format is based on a protocol that is understood by a recipient of the input/output communications.

10. The apparatus of claim 1, wherein the processor is further configured to:
receive a binding preference including a selection of the selected input/output device; and
transmit a binding request to the cloud-resident computer.

11. A non-transitory computer-readable medium having computer program instructions stored thereon, which, when executed on a processor, cause the processor to perform a method comprising:
detecting a plurality of input/output devices, at least a portion of the plurality of input/output devices associated with a unique identifier and available to be communicatively bound to a cloud-resident computer;
receiving a binding preference including a selection of an input/output device and a cloud-resident computer to which the selected input/output device should be communicatively bound, the selection including the unique identifier associated with the selected input/output device;
transmitting a binding request to the selected input/output device; and
communicatively binding the selected input/output device with the cloud-resident computer.

12. The non-transitory computer-readable medium of claim 11, wherein the method further comprises:
presenting a listing of the portion of the plurality of input/output devices to a user.

13. The non-transitory computer-readable medium of claim 11, wherein the method further comprises:
automatically selecting another input/output device for binding with the cloud-resident computer based on the received binding preference.

14. The non-transitory computer-readable medium of claim 11, wherein the method further comprises:
presenting a listing of cloud-resident computers to a user.

15. The non-transitory computer-readable medium of claim 11, wherein the method further comprises:
determining a TCP address for the cloud-resident computer; and
transmitting the TCP address to the selected input/output device.

16. The non-transitory computer-readable medium of claim 11, wherein communicatively binding comprises routing input/output communications between the selected input/output device and the cloud-resident computer.

17. The non-transitory computer-readable medium of claim 16, wherein routing input/output communications between the selected input/output device and the cloud-resident computer includes establishing TCP-based communications between the selected input/output device and the cloud-resident computer.

18. The non-transitory computer-readable medium of claim 16, wherein routing input/output communications between the selected input/output device and the cloud-resident computer includes establishing UDP-based communications between the selected input/output device and the cloud-resident computer.

19. The non-transitory computer-readable medium of claim 16, wherein the method further comprises:
converting input/output communications received from the selected input/output device or the cloud-resident computer from a first format to a second format, wherein the second format is based on a protocol that is understood by a recipient of the input/output communications.

20. The non-transitory computer-readable medium of claim 11, wherein the method further comprises:
receiving a binding preference including a selection of a cloud-resident computer; and
transmitting a binding request to the selected input/output device.

21. A method comprising:
detecting a plurality of input/output devices, at least a portion of the plurality of input/output devices associated with a unique identifier and available to be communicatively bound to a cloud-resident computer;
receiving a binding preference including a selection of an input/output device, the selection including the unique identifier associated with the selected input/output device;
transmitting a binding request to the selected input/output device; and
communicatively binding the selected input/output device with the cloud-resident computer.
